(19) United States
(12) Patent Application Publication
(10) Pub. No.: US 2011/0167993 A1
(43) Pub. Date: Jul. 14, 2011

(54) KEYBOARD HAVING MICRO-ELECTRO-MECHANICAL SENSOR

(75) Inventors: HAI LAN, Tu-Cheng (TW); GA-LANE CHEN, Santa Clara, CA (US); TAI-HSU CHOU, Tu-Cheng (TW)

(73) Assignee: HON HAI PRECISION INDUSTRY CO., LTD., Tu-Cheng (TW)

(21) Appl. No.: 12/817,150

(22) Filed: Jun. 16, 2010

(30) Foreign Application Priority Data
Jan. 14, 2010 (CN) 201010300316.4

(51) Int. Cl. G10H 1/32

(52) U.S. Cl. 84/744

(57) ABSTRACT

A keyboard includes a cover, a base facing and contacting the cover, at least one key, and a micro-electro-mechanical sensor (MEMS) module. The base and the cover define a space for receiving the MEMS module. The at least one key is movably formed on the cover. The MEMS module is sandwiched between the base and the cover and includes a bag, a connecting tube, and a sensor. The bag is resisted with the at least one key. The connecting tube is connected to the bag at one end and communicates with the bag. The sensor is connected to the other end of the connecting tube and communicated with the bag via the connecting tube to generate pressure signals according to a pressure from the key to the bag.

### BACKGROUND

1. Technical Field

The present disclosure relates to a keyboard employing a micro-electro-mechanical sensor (MEMS) module.

2. Description of Related Art

Keyboards are widely used in all kinds of electronic devices such as desktop computers, notebook computers, or electronic organs. A typical keyboard includes a number of keys and a number of resistance sensors or capacitance sensors. The typical keyboard generates touch signals according to the position of each key and duration of touch obtained by the resistance sensors or the capacitance sensors. However, the resistance sensors or the capacitance sensors can not sense how much pressure is applied to each key, such that the typical keyboard can not generate accurate tough signals.

Therefore, a new keyboard is desired to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is schematic, isometric view of a keyboard according to an embodiment of the present disclosure.

FIG. 2 is schematic, exploded solid view of the keyboard of FIG. 1, the keyboard including an MEMS module.

FIG. 3 is schematic, enlarged side view of the MEMS module, showing portion of one key located on a bag of the MEMS module.

### DETAILED DESCRIPTION

Reference will now be made to the drawings to describe various inventive embodiments of the present disclosure in detail, wherein like numerals refer to like elements throughout.

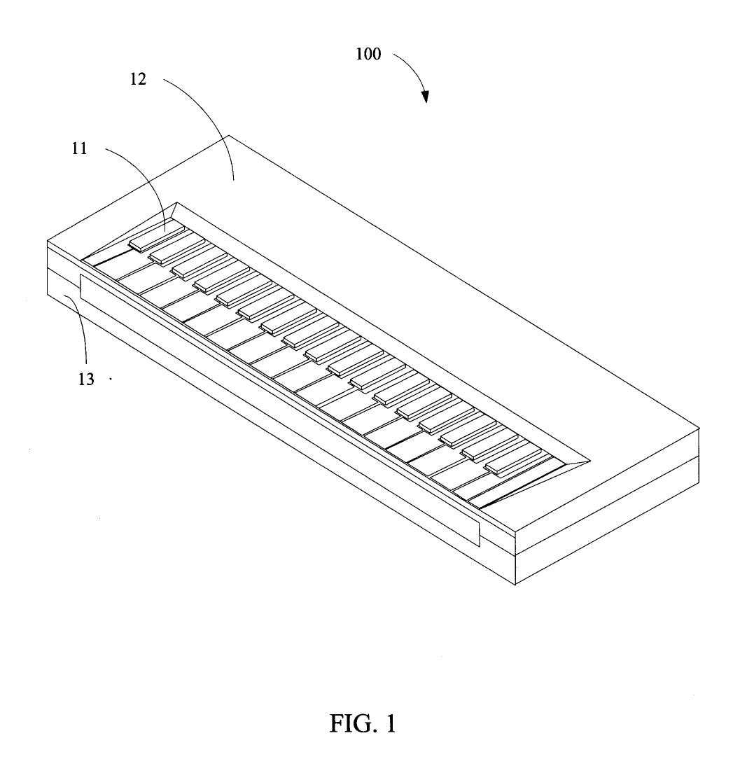

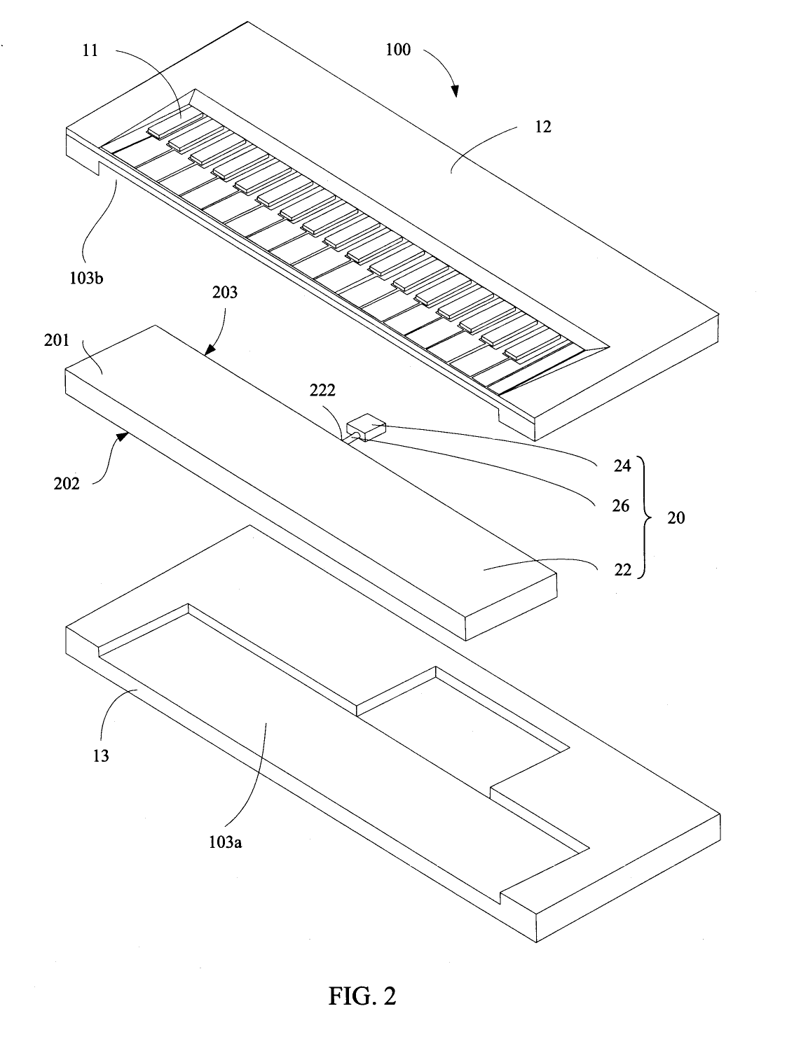

Referring to FIGS. 1 to 3, a keyboard according to one embodiment of the present disclosure is shown. The keyboard 100 includes a number of keys 11, a cover 12, a base 13 facing and contacting the cover 12, and an MEMS module 20 sandwiched between the cover 12 and the base 13.

The base 13 defines a first compartment 103a. The cover 12 defines a second compartment 103b spatially corresponding to the first compartment 103a. The first compartment 103a and the second compartment 103b define a space configured for receiving the MEMS module 20.

Each key 11 includes a top surface 101 and a bottom surface 102 opposite to the top surface 101. The top surface 101 functions as a touch surface or pressing surface for a user to press. The bottom surface 102 functions as a resisting surface to contact the MEMS module 20. In one embodiment, the keys 11 are arranged like the black and white keys of an electronic piano. The top surfaces 101 of the keys 11 are exposed from the cover 12.

The MEMS module 20 includes a bag 22 filled with gas or insulating liquid, a sensor 24, and a connecting tube 26 connected between the bag 22 and the sensor 24.

The bag 22 is received in the space defined by the first and the second compartments 103a and 103b and supported by the base 13. The bag 22 includes a first surface 201, a second surface 202, and a side surface 203 perpendicularly connected between the first surface 201 and the second surface 202. The first surface 201 contacts with the bottom surface 102 of the keys 11. The second surface 202 contacts with the base 13. The side surface 203 is adjacent to side surfaces of the first and the second compartments 103a and 103b when the bag 22 is received in the space. A first opening 222 is defined on the side surface 203 of the bag 22 as an entrance to the bag 22. In one embodiment, an area of the first surface 201 is approximately equal to that of all the bottom surfaces 102 of the keys 11. In this embodiment, the bag 22 is a rectangle-shaped and made of elastic materials such as rubber.

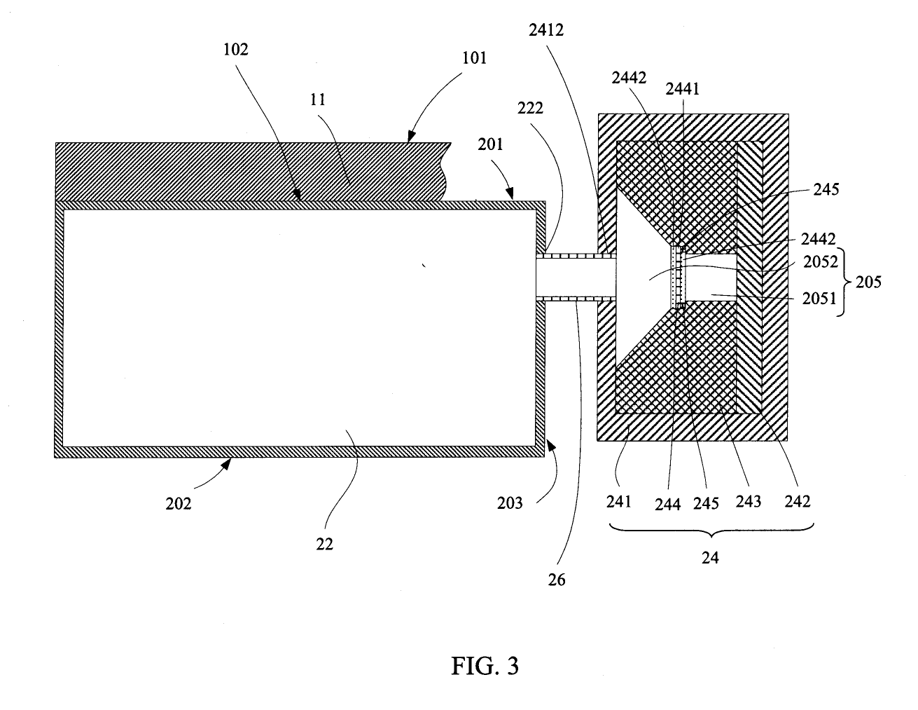

As shown in FIG. 3, the sensor 24 includes a sensing container 241a circuit board 242, a substrate 243, a diaphragm 244, and two electrodes 245 received in the sensing container 241. The sensing container 241 includes a bottom portion and a top portion opposite to each other. The top portion of the sensing container 241 defines a second opening 2412 as an entrance to the sensing chamber 241.

The circuit board 242 is positioned adjacent to the bottom portion of the sensing container 241. The circuit board 242 includes a processor (not shown) connected to the electrodes 245 for transforming vibration variants of the diaphragm 244 into electronic signals. The substrate 243 is located on the circuit board 242 and defines a through hole 205 facing the second opening 2412 of the sensing container 241. The through hole 205 includes a first portion 2051 with constant diameter and a second portion 2052 with tapered diameter. The first portion 2051 is adjacent to the circuit board 242. A narrower part of the second portion 2052 is adjacent to the first portion 2051 and a wider part of the second portion 2052 is adjacent to the second opening 2412.

The diaphragm 244 is positioned at a middle of the through hole 205 to separate the first portion 2051 from the second portion 2052. The second portion 2052 of the through hole 205 communicates with the bag 22 via the connecting tube 26. Two ends of the diaphragm 244 are electrically connected to the processor of the circuit board 242 via the electrodes 245, correspondingly. When the bag 22 is pressed, the pressure from the bag 22 can be transmitted to the diaphragm 244 via the connecting tube 26. Therefore, the diaphragm 244 deforms to generate pressure signals according to the pressure of the bag 22 and sends the pressure signals to the processor of the circuit board 242.

In one embodiment, the diaphragm 244 includes a carbon nanotube film 2441 and two protecting films 2442 sandwiching the carbon nanotube film 2441. Two ends of the carbon nanotube film 2441 are connected to the processor via the electrodes 245. The carbon nanotube film 2441 includes a plurality of carbon nanotubes arranged parallel to each other. Each carbon nanotube extends from one electrode 245 to the other electrode 245. That is, the carbon nanotubes are substantially arranged parallel to a connecting line between the electrodes 245.

When the diaphragm 244 deforms due to the pressure of the bag 22, a resistance of the carbon nanotube film 2441 correspondingly changes. Thus, the processor can correspondingly calculate the pressure of the bag 22 according to the resistance variations of the carbon nanotube film 2441.

Alternatively, the keyboard 100 includes a plurality of sensors 24 connected to the bag 22 via corresponding connecting tubes 26. The sensors 24 are configured to obtain pressures at different positions of the bag 20. Therefore, the MEMS modules 20 can obtain an average pressure according to the pressures at different positions of the bag 20 obtained by the sensors 24.

Furthermore, the keyboard 100 can include a plurality of bags 22, a plurality of connecting tubes 26 and a plurality of sensors 24. Each of the sensors 24 is individually connected to a corresponding bag 22 via a respective one of the connecting tubes 26. Each of the bags 22 corresponds to a respective one of the keys 11. A pressure of each bag 22 can be individually calculated to generate an individual touch signal.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A keyboard comprising:
a cover;
a base facing and contacting the cover, the base and the cover defining a space;
at least one key movably formed on the cover; and
a micro-electro-mechanical sensor (MEMS) module received in the space and sandwiched between the base and the cover, the MEMS module comprising:
a bag resisted with the at least one key;
a connecting tube connected to the bag at one end and communicated with the bag; and
a sensor connected to the other end of the connecting tube and communicated with the bag via the connecting tube to generate pressure signals according to a pressure from the key to the bag.

2. The keyboard of claim 1, wherein the sensor seals the other end of the tube.

3. The keyboard of claim 2, wherein the bag is filled with air or insulating liquid.

4. The keyboard of claim 1, wherein the base defines a first compartment, the cover defines a second compartment facing the first compartment, and the first and the second compartments form the space.

5. The keyboard of claim 1, wherein the at least one key is comprises a top surface and a bottom surface opposite to the top surface, the top surface is exposed from the cover, and the bottom surface resists with the bag of the MEMS module.

6. The keyboard of claim 5, wherein the at least one key comprises a plurality of keys arranged like the black and white keys of an electronic piano.

7. The keyboard of claim 1, wherein the bag is rectangle-shaped and made of elastic materials.

8. The keyboard of claim 5, wherein the bag comprises a first surface supported by the base, a second surface contacted with the bottom surface of the at least one key, and a side surface perpendicularly connected between the first surface and the second surface.

9. The keyboard of claim 8, wherein bag comprises a first opening defined on the side surface of the bag as an entrance to the bag.

10. The keyboard of claim 9, wherein the one end of the connecting tube is connected to the first opening of the bag.

11. The keyboard of claim 10, wherein the sensor comprises a sensing container defining a second opening connected to the other end of the connecting tube.

12. The keyboard of claim 11, wherein the sensor further comprises a substrate and a diaphragm received in the sensing container, the substrate defines a through hole facing the second opening and communicates with the bag via the connecting tube, and the diaphragm is positioned at a middle of the through hole.

13. The keyboard of claim 12, wherein the diaphragm comprises a carbon nanotube film and two protecting films sandwiching the carbon nanotube film.

14. The keyboard of claim 13, wherein the sensor further comprises a circuit board, two ends of the diaphragm are electrically connected to the circuit board.

15. The keyboard of claim 14, wherein the carbon nanotube film comprises a plurality of parallel carbon nanotubes.

16. The keyboard of claim 12, wherein the through hole comprises a first portion with constant diameter and a second portion with tapered diameter, the second portion is adjacent to the second opening, the first portion is far from the second opening and adjacent to the substrate, and the diaphragm separates the first portion from the second portion.

17. The keyboard of claim 16, wherein a narrower part of the second portion is adjacent to the first portion and a wider part of the second portion is adjacent to the second opening.

18. A keyboard comprising:
a base;
a cover contacting the base, a space being defined between the cover and the base;
a plurality of keys movably positioned on the cover; and
a MEMS module, comprising:
a bag positioned between the cover and the base and received in the space, the bag being capable of being pressured by the keys;
a connecting tube; and
a sensor comprising a sensing container, a circuit board, a substrate and a diaphragm, wherein the circuit board, the substrate and the diaphragm are received in the sensing container, the substrate defines a through hole, the diaphragm is electrically connected to the circuit board and positioned at a middle of the through hole, and the connecting tube connects the sensing container to the bag and communicates with the through hole and the bag.

19. The keyboard of claim 18, wherein the diaphragm comprises a carbon nanotube film and two protecting films sandwiching the carbon nanotube film, and the carbon nanotube film comprises a plurality of parallel carbon nanotubes.

20. The keyboard of claim 18, wherein the bag is made of elastic material.
